(19) United States
(12) Patent Application Publication
(10) Pub. No.: US 2007/0296855 A1
(43) Pub. Date: Dec. 27, 2007

(54) Video processing using region-based statistical measurements

(76) Inventors: Yunwei Jia, Milton (CA); Gheorghe Berbecel, Tronto (CA)

Correspondence Address: David B. Cochran, Esq.;Jones Day, North Point, 901 Lakeside Avenue, Cleveland, OH, 44114, US

(21) Appl. No.: 11/472,814

(22) Filed: Jun. 22, 2006

(51) Int. Cl. H04N 7/01

(52) U.S. Cl. 348/441; 348/446

(57) ABSTRACT

A methodology and structure is described for processing a video signal comprising a plurality of fields. Each of the fields of the video signal are partitioned into a plurality of regions. Statistical measurements are then performed on each field to detect a field-level temporal periodic pattern and on each region within the fields to detect a region-level temporal periodic pattern. The regions in each field are then processed using the field-level temporal periodic pattern and the region-level temporal periodic pattern.

### BACKGROUND

1. Technical Field

The technology described in this patent application is generally directed to the field of video processing. More specifically, a video processing system and method is described in which field-based and region-based statistical measurements are made to detect temporal periodic patterns in an associated video signal. The field and region based measurements are then used to determine how to properly process the video signal.

2. Description of the Related Art

Motion picture films are normally shot at 24 progressive frames per second. In order to display the film on a television screen, it is often necessary to convert the film from its progressive source into an interlaced video signal, typically either NTSC format (60 interlaced fields per second), or PAL format (50 interlaced fields per second). The process of converting a progressive film source to an interlaced video signal is called telecine.

There are two commonly used methods for telecine: (i) 3:2 pulldown for converting films to NTSC video signals; and (ii) 2:2 pulldown for converting films to PAL video signals. In the 3:2 pulldown method of telecine, three video fields and two video fields are alternatively obtained from two consecutive progressive film frames. In the case of three video fields from a progressive film frame, the third field repeats the first one. For example, if the sequence of progressive film frames is F0 F1 F2 F3, . . . , etc., then the converted sequence of interlaced video fields in 3:2 pulldown is T0 B0 T0 B1 T1 B2 T2 B2 T3 B3, . . . , etc., where Fi is a progressive film frame, Ti is the top field from Fi, and Bi is the bottom field from Fi. In 2:2 pulldown, two interlaced video fields are obtained from a progressive film frame. For example, if the sequence of progressive film frames is F0 F1 F2 F3 . . . , then the converted sequence of interlaced video fields is T0 B0 T1 B1 T2 B2 T3 B3, . . . , etc.

In order to display a sequence of interlaced video fields on a progressive display device, such as an LCD TV or a Plasma TV, the interlaced video sequence is typically converted into a sequence of progressive frames through a process known as de-interlacing. There are many different methods of de-interlacing an interlaced video signal, such as “bob” (spatial interpolation), “weave” (field merging), motion adaptive de-interlacing, and motion compensated de-interlacing. These de-interlacing methods vary in terms of complexity and visual performance depending on the contents of the interlaced video sequence.

For video sequences generated from film material through telecine, if the display device can detect which two fields originated from the same progressive frame during the telecine process, then the de-interlacer can perform a simple field-merging operation, which typically results in superior visual display performance. The process of determining whether a video sequence is generated from film material through telecine and which two fields originated from the same progressive frame during telecine is called film mode detection. Film mode detection is typically performed by making various statistical measurements on the input video sequence.

Film mode detection is complicated by a number of factors, such as, for example, (i) noise, which may reduce the reliability of the statistical measurements on the input sequence, (ii) scene changes, which may break the regular telecine patterns in the input sequence, and (iii) post-edits in which different types of material may be mixed together in one sequence. The first factor—noise—can be reduced by pre-filtering the input video sequence. The second factor—scene changes—can be alleviated by look-ahead techniques. But the third factor—post-edits—can be more difficult to handle. The following types of post-edits may create problems when attempting to detect the film mode of an input sequence:

(1) video over film—moving interlaced text (such as a news alert, weather forecast, stock information, etc.) is overlaid on a regularly telecined video sequence. If such a sequence is detected as regularly telecined and thus field merging is performed in the de-interlacing step, then noticeable “feathering” artifacts will show up around the moving text;

(2) film over video—moving progressive (2:2 pulldown-ed) objects (such as a television station logo or special effects, etc.) are overlaid onto slow-moving interlaced video. If such a sequence is detected as regularly telecined (2:2, e.g.) and thus field merging is performed in the de-interlacing step, then noticeable “feathering” artifacts will show up around the moving interlaced video objects; and

(3) mixture of different cadences/telecine phases—a video sequence may include a mix of video sequences that are converted from progressive sources through different methods and/or the same method but at different phases. The mixture of sequences may be at the picture level, i.e., different objects in a picture may have different telecine patterns and/or phases. For example, a video sequence may include the mixture of two video sequences that are regularly 3:2 pull-downed from two progressive sources but have different pull-down phases. The phase of a temporally periodic pattern may be defined, generally, as a distinguishable state in a period of the pattern. For example, consider the example pattern shown in FIG. 4, discussed in more detail herein. The pattern shown in this figure has a period of five fields and each period consists of four relatively large SAD (sum of absolute differences) values and only on relatively small SAD value. This temporal pattern has five phases, with phase 0 to phase 3 corresponding, respectively, to the first four SAD values in a period and phase 4 corresponding to the small SAD in a period. If such a mixed sequence is detected as regularly 3:2 pull-downed and thus field merging is performed in the de-interlacing step, then noticeable “feathering” artifacts will show up around some of the moving objects.

Prior art film mode detection is typically done at either the field-level or the pixel-level. Field-based film mode detection typically collects statistical measurements over an entire video field and makes a decision on the film mode for the entire field. Although such a technique is simple to implement, it may fail to generate acceptable visual performance, especially for video sequences having post-edits, such as the three cases mentioned above.

Pixel-based film detectors attempt to determine the film mode for each individual pixel in the video sequence. It is very unusual, however, that individual pixels in a video field would have their own random film modes. Even in the cases of post-edits, such as those mentioned above, pixels are grouped together as an object that may have a film mode different from other objects in the same scene. In addition, pixel-based detectors not only have to gather and process statistical measurements from each pixel individually, but they also need to store and convey the film mode decision for each pixel to the de-interlacer. This results in high computation complexity and storage requirements.

### SUMMARY

A methodology and structure is described for processing a video signal comprising a plurality of fields. Each of the fields of the video signal is partitioned into a plurality of regions. Statistical measurements are then performed on each field to detect a field-level temporal periodic pattern and on each region within the fields to detect a region-level temporal periodic pattern. The regions in each field are then processed using the field-level temporal periodic pattern and the region-level temporal periodic pattern.

### BRIEF DESCRIPTION OF THE DRAWINGS

FIG. 1 is a flow chart describing an example method of region-based film mode detection and de-interlacing;

FIG. 2 is a diagram depicting block-based film mode detection using statistical measurements gathered from co-located blocks in a video sequence;

FIG. 3 is a flow chart describing an example block-based film mode detection process for 3:2 pulldown detection;

FIG. 4 illustrates the summation of absolute pixel differences (SAD) measurement that typifies the 3:2 pulldown pattern; and

FIG. 5 is an example block diagram of a video processing device for performing region-based film mode detection and de-interlacing.

### DETAILED DESCRIPTION

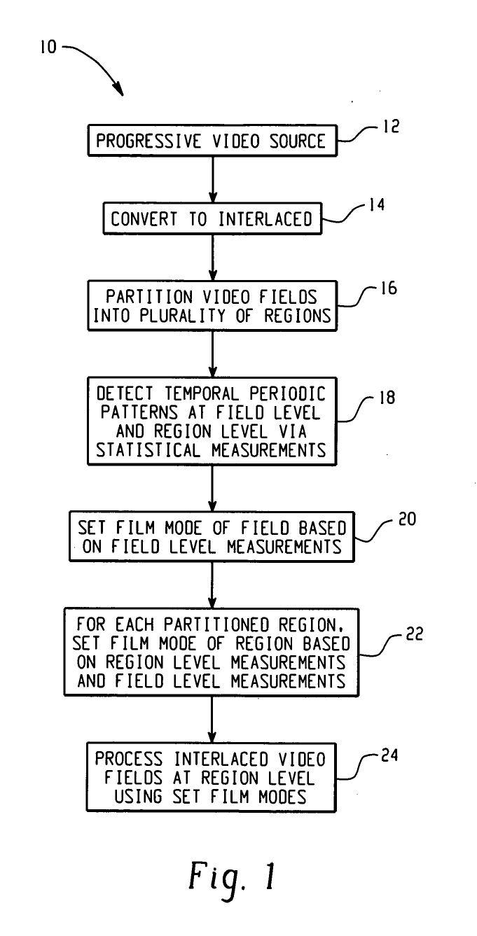

Turning now to the drawing figures, FIG. 1 is a flow chart 10 describing an example method of region-based film mode detection and processing. Although described in relation to film mode detection, the methodology described in this patent application is applicable to any video processing function in which temporal periodic patterns may be detected in a sequence of video fields generated from a source that is progressive in nature. Clearly, film mode in telecined video sequences is a special case of such temporal periodic patterns. In the following detailed description, film mode detection and subsequent de-interlacing will be used as examples to illustrate the advantages of this methodology.

Beginning with step 12, a progressive video source is provided, such as a motion picture film. The progressive signal is then converted into a plurality of interlaced video fields in step 14, such as by 3:2 or 2:2 pulldown telecine techniques, as described above. The telecined video fields may comprise a sequence of interlaced top fields, or odd-parity fields, and bottom fields, or even-parity fields. In step 16, each of the interlaced video fields is then partitioned into a plurality of regions. A region can be a horizontal stripe in a field, or a vertical stripe in a field, or it may be defined by a number of neighboring blocks, or a single block of certain size. A block may be a group of connected pixels where two pixels X and Y are said to be connected if X is one of the eight neighbors of Y and vice versa. The region size and/or dimensions can be set to constant values while processing the interlaced video sequence, or, alternatively, the region size and/or dimensions can be dynamically adjusted based upon the content of the interlaced sequence. Ideally, the region is chosen to be small enough to capture film mode variations from region to region in a field, and yet large enough to minimize storage and computational complexity of the video processing system/device implementing the methodology.

The sequence of partitioned interlaced video fields from step 16 can be defined as f(0), f(1), f(2), . . . , where f(n) is the current field whose film modes are to be determined. The plurality of partitioned regions of f(n) may have different film modes and/or different phases due to possible post-edits as described above. In step 18, statistical measurements are taken on f(n) and its neighboring fields (the fields immediately before and after f(n)), both at field level and region level, in order to detect a temporal periodic pattern in the field/regions. A variety of different types of statistical measurements could be employed in this step, such as the sum of absolute differences (SAD) measurements discussed below.

The plurality of regions in a field f(n) from which the statistical measurements are collected may be overlapping or non-overlapping. In the case of regions defined as a plurality of blocks, if the blocks are non-overlapping, then the blocks is referred to herein as tiles. Thus, tiles are non-overlapping blocks. The plurality of regions in a field from which statistical measurements are collected may not cover the entire field area. This limited-coverage implementation may be desirable to reduce the storage and computational complexity of the device or system implementing the method. Moreover, the regions in a given field may have distinct spatial structures. Thus, for example, the entire top portion of the field could be a single region, whereas the bottom portion of the field includes a plurality of smaller regions, such as blocks.

Following the statistical measurements in step 18, in step 20 the film mode of each field is set based upon the field level statistical measurements. Then, in step 22, the film mode of each of the partitioned regions in the field is set based upon both the field level statistical measurements and the region level measurements. Typically, if the field level and region level measurements are consistent, then the film mode of the region is set to be the same as the film mode of the entire field. But if the measurements are not consistent, then the film mode of the region is typically set to be either interlaced or that which is indicated by the region level statistics. The determination of the film mode for a region may also take into consideration statistical measurements from other neighboring regions, or from co-located regions in neighboring fields.

Finally, in step 24, the film mode data for the fields and the plurality of regions within the fields, is utilized to process the interlaced video sequence at the region level. An example of this processing step could be a de-interlacing function in which certain regions of a field in the video sequence are de-interlaced using one technique while other regions of the same field are de-interlaced using a different technique.

The methodology described in FIG. 1 is capable of avoiding “feathering” artifacts in regions with film modes that are different from other regions in the same scene, and yet retains full resolution for other regions of the scene whose film modes are consistent. This is advantageous for video sequences with post-editing in which video and film may be mixed together or different telecine pattern/phases appear in different objects in a scene.

In one example of this methodology, a region is defined as a number of neighboring horizontal lines in a field. When a telecine pattern (for example, 3:2 or 2:2 pulldown) is detected at the field level, then each region in the field is examined to determine whether its local statistical measurements are contradictory to the detected field-level film mode. If they are not contradictory, then the film mode of a particular region is set to be the same as the field-level film mode; otherwise, the film modes of the current region and all the remaining regions in the field are set to interlaced mode.

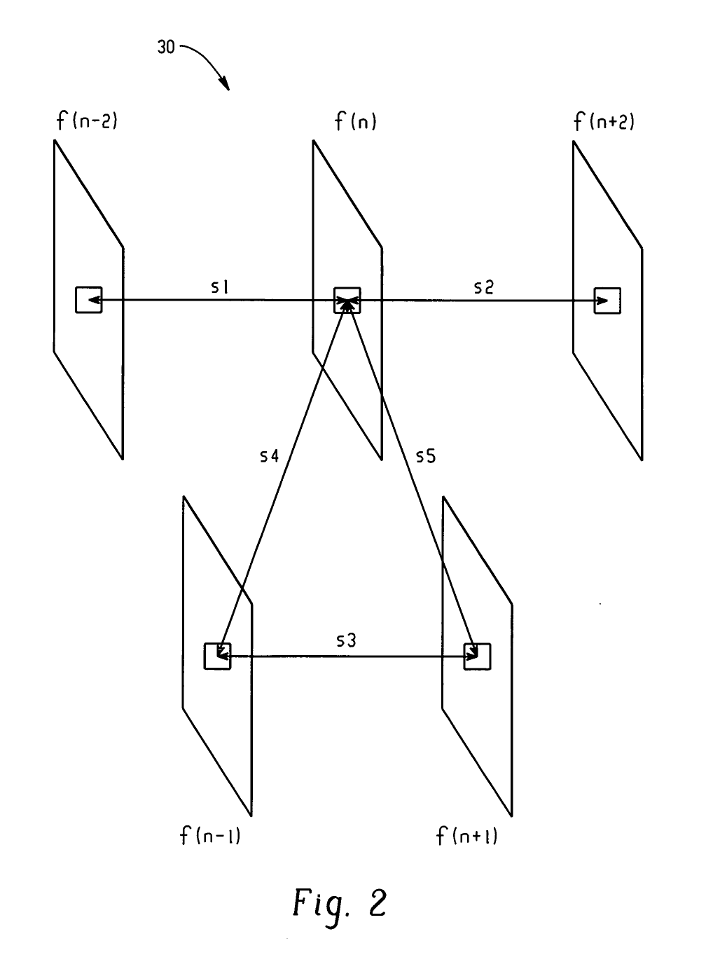

FIG. 2 is a diagram 30 depicting block-based film mode detection using statistical measurements gathered from co-located blocks in a video sequence. In this figure, each block of pixels (for example, 4 pixels vertically by 8 pixels horizontally) is considered a region. After determining the field-level film mode, the film mode for each block is determined by weighting a number of factors, which may include: (1) the statistical measurements of the block; (2) the statistical measurements from its neighboring blocks; (3) statistical measurements from a larger block that includes the current block; (4) any available mode decisions of its neighboring blocks or a larger block which includes the current block; and (5) the field-level decision.

For example, consider a block “A” and its eight neighboring blocks “B” to “I”, as shown below.

| | | |
|---|---|---|
| B | C | D |
| E | A | F |
| G | H | I |

The film mode of the block “A” may be determined according to the following rules: (i) if the statistical measurements of the block “A” and at least t1 of its eight neighboring blocks indicate the same film mode as the field-level film mode, then set the film mode of “A” to be the same as the field-level mode. In this rule, t1 is a programmable parameter in the range of 0˜8, with a default value 5; (ii) otherwise, if the statistical measurements of the block “A” and at least t2 of its eight neighboring blocks indicate the same film mode, but which is different from the field-level film mode, then set the film mode of “A” as indicated by its statistic measurements. Here, t2 is a programmable parameter in the range of 0˜8 with default value 8.; (iii) otherwise, set the film mode of “A” to be interlaced.

Turning back to FIG. 2, consider a block in the field f(n) and its co-located blocks in f(n−2) and f(n+2) (both fields have the same parity as f(n)), and its co-located blocks in f(n−1) and f(n+1) (both fields have the opposite parity to f(n)). In this figure, the variable s1 is used to represent the similarity between the block in f(n) and its co-located block in f(n−2), the variable s2 represents the similarity between the block in f(n) and its co-located block in f(n+2), the variable s3 represents the similarity between its co-located block in f(n−1) and its co-located block in f(n+1), the variable s4 represents the similarity between the block in f(n) and its co-located block in f(n−1), and the variable s5 represents the similarity between the block in f(n) and its co-located block in f(n+1.

The similarity between two blocks can be, for example, based on the sum-of-absolute-differences (SAD) of all the co-sited pixels in the two blocks. In the case that the two blocks are in two fields having different parities, then SAD can be measured between vertically-neighboring pixels in the two fields. The similarity between two blocks can be measured in a variety of other ways.

For each block in f(n), its film mode can be determined based on a history of these similarity measurements for a number of past fields. To achieve this, a history of the statistical measurements (s1 to s5) for each block in a field is tracked and stored in a memory. Although a very small block size may lead to better visual performance of the subsequent de-interlacing function, this will likely result in more complex computations and increased storage requirements for the device/system implementing the methodology. Thus, a reasonable trade-off between visual performance and storage/computation complexity can be achieved by using a reasonable small block size, but one that is not too small so as to increase the storage/computational requirements of the device. The prior art field and pixel-based methodologies do not provide for this type of performance/complexity trade-off. Ultimately, the device performing the video processing function can be programmed by a user with different block sizes depending upon whether the user is interested in maximizing visual performance or storage/computational complexity.

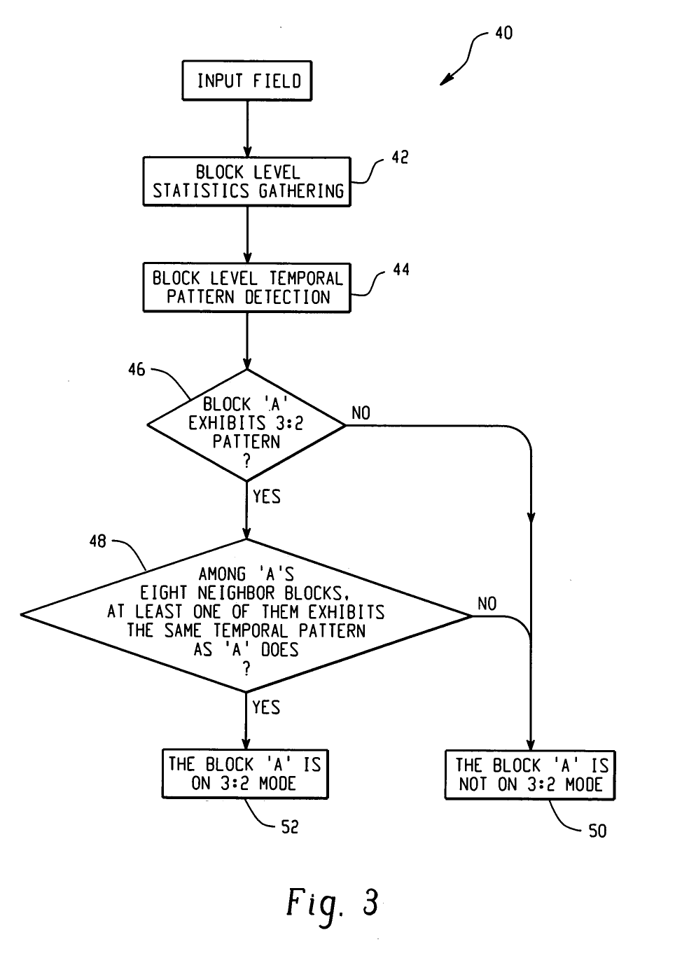

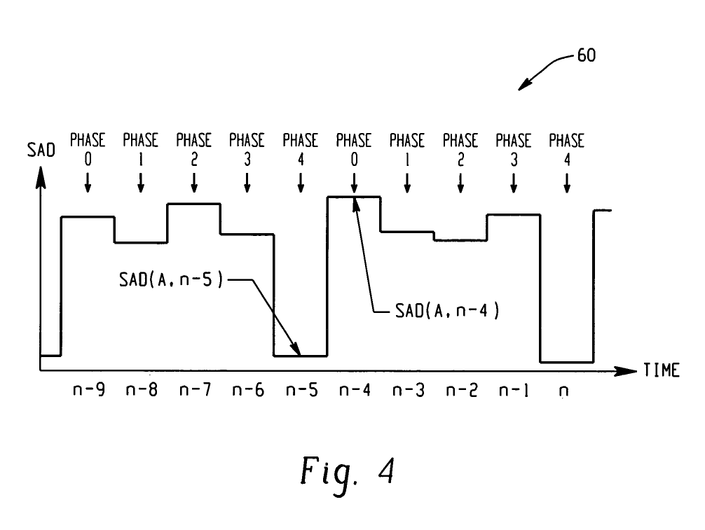

FIG. 3 is a flow chart describing an example block-based film mode detection process for 3:2 pulldown detection. Beginning with step 42, for each block A of an input field f(n), a variable SAD(A, n) is calculated, which is defined as the summation of the absolute pixel differences between the pixels in the block A in the field f(n) and the pixels in the co-located block in the previous same-parity field f(n−2). Following these calculations, in step 44, for each block A in the input field f(n), the temporal history of the collected statistics for this block are examined and a determination is made as to whether a temporal pattern is detected in the data. For 3:2 pulldown detection, for example, the most recent 10 values of SAD for this block may be examined in step 46 to detect the existence of a temporal pattern, i.e., SAD(A, k) for k=n-9, n-8, . . . , n. FIG. 4 illustrates the summation of absolute pixel differences (SAD) measurement that typifies the 3:2 pulldown pattern.

If this detection step 46 indicates that there are two relatively small SADs separated by four relatively large SADs, then the block A exhibits the 3:2 pattern and control passes to step 48. Otherwise, the block does not exhibit the 3:2 pattern and thus in step 50 the block is not set to 3:2 mode. At step 48, the neighboring blocks of the block A are examined. If among the eight immediate neighboring blocks, at least 5, for example, of the blocks have the same 3:2 temporal pattern as does block A, then block A is determined to be on 3:2 mode as in step 52; otherwise, block A is not on 3:2 mode as in step 50.

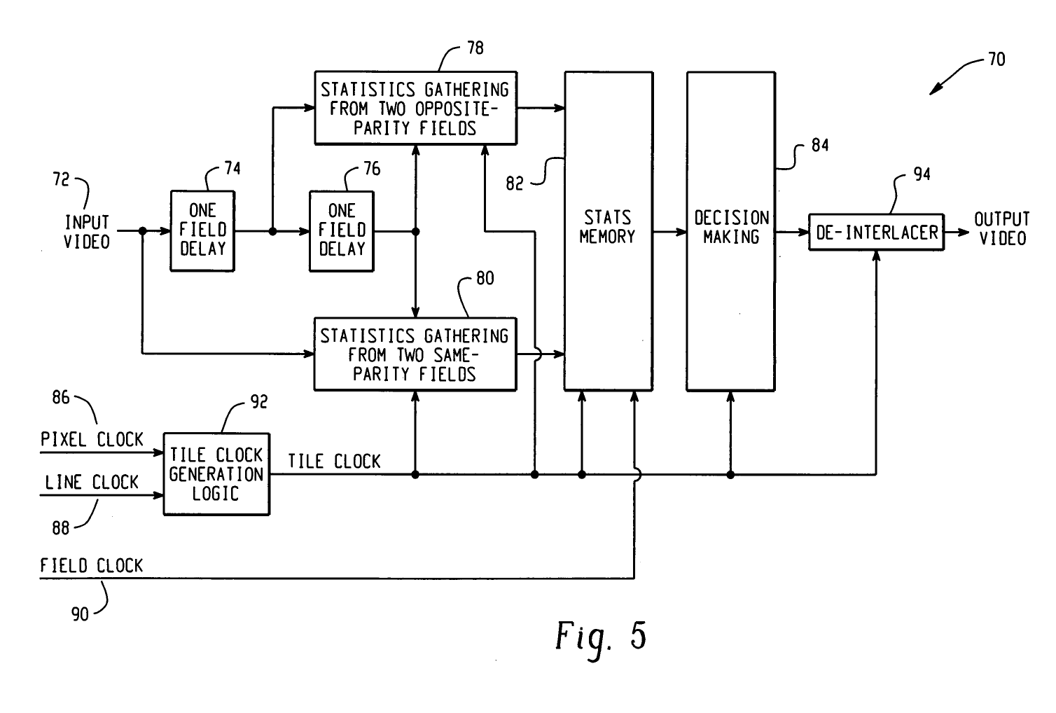

FIG. 5 is an example block diagram of a video processing device 70 for performing region-based film mode detection and de-interlacing. The device may include two one-field delay blocks 74, 76; two statistics gathering blocks 78, 80, a memory 82, a decision making block 84, tile clock generation logic 92, and a de-interlacer 94.

Operationally, each input field from the input video signal 72 is partitioned into tiles. For example, each tile may be a non-overlapping block of 8 pixels wide and 4 lines high. Statistics are gathered for each tile using the blocks 78, 80, including statistics from the tile in the current field and its co-located tile in the previous same-parity field (block 80), and from the tile in the current field and its co-located tile in the previous opposite-parity field (block 78). The field delay blocks 74, 76 are utilized to provide these opposite and same parity fields to the statistics gathering blocks 78, 80.

The gathered statistics from these blocks 78, 80 are then stored in a statistics memory 82. The statistics memory 82 may include, for example, 10 segments, with each segment storing the statistics gathered for each of the most recent 10 fields. The statistics memory 82 may be utilized in a circular manner at the segment level, i.e., when a new field comes in, the statistics gathered for this new field overwrites the segment corresponding to the most ancient field in the memory.

Each segment in the memory 82 may be further partitioned into a number of cells, with each cell storing the statistics gathered for a tile in the field. This technique provides a unique one-to-one mapping between the tiles in a field and the cells in the memory segment corresponding to this field. The gathered statistics are written into the statistics memory 82 at the tile clock, which is generated by the tile clock generation logic 92 from the pixel clock 86 and line clock 88 in the input video.

The data from the statistics memory 82 is provided to the decision making block 84 on the field clock 90. For each tile in an input field, the statistics of the tile and its neighboring tiles in the same field are examined, as are the statistics of the co-located tiles in the previous 9 fields. The statistics of the spatially-neighboring tiles of the co-located tiles may be considered as well in this block 84. If the statistics match a temporal pattern of a certain film mode, then the decision making block 84 determines that the tile is on the particular film mode with a certain phase. This determination is then provided to the subsequent de-interlacer 94 for the proper processing of the tile into the output video signal.

This written description uses examples to disclose the invention, including the best mode, and also to enable a person skilled in the art to make and use the invention. The patentable scope of the invention may include other examples that occur to those skilled in the art.

It is claimed:

1. A method of processing a video signal comprising a plurality of fields, comprising:
partitioning each of the fields into a plurality of regions;
performing statistical measurements on each field to detect a field-level temporal periodic pattern;
performing statistical measurements on each of the plurality of regions in each field to detect a region-level temporal periodic pattern; and
processing the regions in each field using the field-level temporal periodic pattern and the region-level temporal periodic pattern.

2. The method of claim 1, wherein the video signal is from a progressive source, the method further comprising:
converting the progressive video signal into an interlaced video signal comprising the plurality of fields.

3. The method of claim 2, further comprising: post-editing the interlaced video signal prior to the partitioning step.

4. The method of claim 3, wherein the post-editing step includes at least one of the steps of overlaying interlaced text on the interlaced video signal, overlaying progressive objects on the interlaced video signal, or mixing one or more video sequences into the interlaced video signal, wherein the one or more video sequences are converted from progressive video sources.

5. The method of claim 4, wherein the processing step reduces visual artifacts associated with the post-edited text, objects or sequences in the interlaced video signal.

6. The method of claim 1, wherein the partitioning step further comprises:
partitioning at least one field into a plurality of horizontal stripes, the plurality of horizontal stripes comprising the regions of the field.

7. The method of claim 1, wherein the partitioning step further comprises:
partitioning at least one field into a plurality of vertical stripes, the plurality of vertical stripes comprising the regions of the field.

8. The method of claim 1, wherein the partitioning step further comprises:
partitioning at least one field into a plurality of blocks, the plurality of blocks comprising the regions of the field and being defined by a plurality of horizontal pixels by a plurality of vertical pixels.

9. The method of claim 8, wherein the plurality of blocks are non-overlapping.

10. The method of claim 1, wherein the partitioning step further comprises:
partitioning at least one field into at least two distinct regions, wherein one of the two distinct regions is defined by a first partitioning dimension and the second of the two distinct regions is defined by a second partitioning dimension.

11. The method of claim 10, wherein the first partitioning dimension is a horizontal stripe of a first number of video lines and the second partitioning dimension is a horizontal stripe of a second number of video lines.

12. The method of claim 10, wherein the first partitioning dimension is a block of a first number of horizontal and vertical pixels and the second partitioning dimension is a block of a second number of horizontal and vertical pixels.

13. The method of claim 10, wherein the first partitioning dimension is a horizontal stripe of a first number of video lines and the second partitioning dimension is a block of a first number of horizontal and vertical pixels.

14. The method of claim 10, further comprising the step of:
dynamically adjusting the first and/or second partitioning dimension based upon the content of the video signal.

15. The method of claim 1, wherein the statistical measurements on each field comprise a sum of absolute differences (SAD) measurement.

16. The method of claim 1, wherein the statistical measurements on each region comprise a sum of absolute differences (SAD) measurement.

17. The method of claim 1, wherein the field-level temporal periodic pattern is indicative of the film mode of the field.

18. The method of claim 17, wherein the region-level temporal periodic pattern is indicative of the film mode of the region.

19. The method of claim 18, wherein the processing step further comprises:
setting the film mode of each field based upon the field-level statistical measurements;
comparing the film mode of each region to the film mode of its field; and
if the film mode of the region is consistent with the film mode of its field, then setting the film mode of the region based upon the field-level statistical measurements, otherwise setting the film mode of the region based upon the region-level statistical measurements.

20. The method of claim 18, wherein the processing step further comprises:
setting the film mode of the region based upon region-level statistical measurements from neighboring regions within the same field.

21. The method of claim 18, wherein the processing step further comprises:
setting the film mode of the region based upon region-level statistical measurements from co-located regions within other fields.

22. The method of claim 18, wherein the processing step further comprises:
de-interlacing the video signal at the region level using the set film modes for each field and region within the fields.

23. The method of claim 22, wherein at least one region is de-interlaced using a first de-interlacing technique and at least one region is de-interlaced using a second de-interlacing technique.

24. The method of claim 1, further comprising:
storing the statistical measurements for each field and region in a memory device so as to maintain a history of the statistical measurements; and
processing the regions in each field using the history data for each region stored in the memory device.

25. A device for processing a video signal comprising a plurality of fields, comprising:
means for partitioning each of the fields into a plurality of regions;
processing circuitry for performing statistical measurements on each field to detect a field-level temporal periodic pattern and for performing statistical measurements on each of the plurality of regions in each field to detect a region-level temporal periodic pattern; and
decision-making logic for analyzing the field-level and region-level temporal periodic patterns and for assigning a video signal characteristic to each region of the video signal.

26. The device of claim 25, wherein the video signal is from a progressive source, the device further comprising:
circuitry for converting the progressive video signal into an interlaced video signal comprising the plurality of fields.

27. The device of claim 25, wherein the means for partitioning partitions at least one field into a plurality of horizontal stripes, the plurality of horizontal stripes comprising the regions of the field.

28. The device of claim 25, wherein the means for partitioning partitions at least one field into a plurality of vertical stripes, the plurality of vertical stripes comprising the regions of the field.

29. The device of claim 25, wherein the means for partitioning partitions at least one field into a plurality of blocks, the plurality of blocks comprising the regions of the field and being defined by a plurality of horizontal pixels by a plurality of vertical pixels.

30. The device of claim 29, wherein the plurality of blocks are non-overlapping tiles.

31. The device of claim 25, wherein the means for partitioning partitions at least one field into at least two distinct regions, wherein one of the two distinct regions is defined by a first partitioning dimension and the second of the two distinct regions is defined by a second partitioning dimension.

32. The device of claim 31, wherein the first partitioning dimension is a horizontal stripe of a first number of video lines and the second partitioning dimension is a horizontal stripe of a second number of video lines.

33. The device of claim 31, wherein the first partitioning dimension is a block of a first number of horizontal and vertical pixels and the second partitioning dimension is a block of a second number of horizontal and vertical pixels.

34. The device of claim 31, wherein the first partitioning dimension is a horizontal stripe of a first number of video lines and the second partitioning dimension is a block of a first number of horizontal and vertical pixels.

35. The device of claim 31, further comprising:
means for dynamically adjusting the first and/or second partitioning dimension based upon the content of the video signal.

36. The device of claim 25, wherein the statistical measurements on each field comprise a sum of absolute differences (SAD) measurement.

37. The device of claim 25, wherein the statistical measurements on each region comprise a sum of absolute differences (SAD) measurement.

38. The device of claim 25, wherein the assigned video signal characteristic is the film mode of the region within each field of the video signal.

39. The device of claim 38, wherein the decision making logic comprises:
means for setting the film mode of each field based upon the field-level statistical measurements;
means for comparing the film mode of each region to the film mode of its field; and
means for determining whether the film mode of the region is consistent with the film mode of its field, and if so then setting the film mode of the region based upon the field-level statistical measurements, otherwise setting the film mode of the region based upon the region-level statistical measurements.

40. The device of claim 39, wherein the decision making logic further comprises:
means for setting the film mode of the region based upon region-level statistical measurements from neighboring regions within the same field.

41. The device of claim 39, wherein the decision making logic further comprises:
means for setting the film mode of the region based upon region-level statistical measurements from co-located regions within other fields.

42. The device of claim 39, further comprising:
a de-interlacer for de-interlacing the video signal at the region level using the set film modes for each field and region within the fields.

43. The device of claim 42, wherein at least one region is de-interlaced using a first de-interlacing technique and at least one region is de-interlaced using a second de-interlacing technique.

44. The device of claim 25, further comprising:
a memory for storing the statistical measurements for each field and region.

45. The device of claim 44, wherein the memory includes a plurality of segments, each segment storing the statistics for a plurality of fields and regions.

46. The device of claim 45, wherein the plurality of segments in the memory are organized into a circular buffer for storing the statistical measurements.
